(19) United States
(12) Patent Application Publication
(10) Pub. No.: US 2013/0316241 A1
(43) Pub. Date: Nov. 28, 2013

(54) Positive Electrode Active Material for a Lithium Secondary Battery, Method for Preparing Same, and Lithium Secondary Battery Comprising Same

(71) Applicants: Sung Woo Oh, Daejeon (KR); Hee Young Sun, Gyeonggi-do (KR); Yu Rim Do, Seoul (KR); Hyung Bok Lee, Seoul (KR)

(72) Inventors: Sung Woo Oh, Daejeon (KR); Hee Young Sun, Gyeonggi-do (KR); Yu Rim Do, Seoul (KR); Hyung Bok Lee, Seoul (KR)

(73) Assignee: SK INNOVATION CO., LTD., Seoul (KR)

(21) Appl. No.: 13/876,679

(22) PCT Filed: Sep. 28, 2011
(86) PCT No.: PCT/KR11/07134

§ 371 Date: Aug. 15, 2013

(30) Foreign Application Priority Data
Sep. 30, 2010 (KR) 10-2010-0095294
Sep. 27, 2011 (KR) 10-2011-0097354

(51) Int. Cl. H01M 4/525

(52) U.S. Cl. CPC H01M 4/525
USPC 429/221; 252/182.1

(57) ABSTRACT

Provided is a high-capacity positive electrode active material, and more particularly, a high-capacity positive electrode active material for a lithium secondary battery containing a composite oxide of the following Chemical Formula 1.

LiₓNi_{y}Fe_{z}Mn_{w}O₂ [Chemical Formula 1]

(Where, x, y, and z satisfy the following Equations, respectively: 1≦x≦1.8, 0<y≦0.13, 0<z≦0.13, and 0.6≦w≦1.)

### TECHNICAL FIELD

The present invention relates to a positive electrode active material for a lithium secondary battery, a method for preparing the same, and a lithium secondary battery containing the same, and more particularly, to a positive electrode active material for a lithium secondary battery having improved electro-chemical properties, a method for preparing the same, and a lithium secondary battery containing the same.

### BACKGROUND ART

As a positive electrode active material for a lithium secondary battery, LiCoO₂, LiMn₂O₄, LiNiₓCo_{y}Mn_{z}O₂, and the like, have been mainly used. However, in accordance with the development of a middle and large-sized battery (hybrid electric vehicle (HEV), plug-in hybrid electric vehicle (PHEV), electric vehicle (EV)), a problem such as safety of the battery has been in the spotlight. In the case of the positive electrode active materials currently commercialized, since the positive electrode active material is expensive or there is a problem in terms of safety, or the like, research into a new positive electrode active material has been conducted.

However, recently, as a battery for an electric vehicle (EV) has been required, the development of a high-capacity positive electrode active material has been urgently demanded.

### DISCLOSURE

### Technical Problem

An object of the present invention is to provide a high-capacity positive electrode active material.

Another object of the present invention is to provide a method for preparing the high-capacity positive electrode active material.

Still another object of the present invention is to provide a lithium secondary battery containing the positive electrode active material.

The technical objects of the present invention are not limited to the above-mentioned technical objects, and other technical objects that are not mentioned will be clearly understood by those skilled in the art through the following descriptions.

### Technical Solution

In one general aspect, there are provided a high-capacity positive electrode active material for a lithium secondary battery including a composite oxide represented by the following Chemical Formula 1, and a method for preparing the same.

LiₓNi_{y}Fe_{z}Mn_{w}O₂ [Chemical Formula 1]

(Where, x, y, and z satisfy the following Equations, respectively: 1≦x≦1.8, 0<y≦0.13, 0<z≦0.13, and 0.6≦w≦1).

In another general aspect, there are provided a high-capacity positive electrode active material for a lithium secondary battery containing a composite oxide represented by the following Chemical Formula 2 or 3, and a method for preparing the same.

Li_{1.2}Ni_{0.13}Fe_{0.13}Mn_{0.74}O₂ [Chemical Formula 2]

Li_{1.2}Ni_{0.104} Fe_{0.104}Mn_{0.592}O₂ [Chemical Formula 3]

The method for preparing the high-capacity positive electrode active material according to the present invention includes:

adding a nickel source material, an iron source material, and a manganese source material to alcohol to prepare a metal mixed solution;

controlling a pH of the metal mixed solution between 5 to 12 to induce a reaction of the metal mixed solution;

drying the hydrate prepared by the reaction in a vacuum oven; and

mixing a lithium source material with the hydrate and then heat-treating the mixture under inert atmosphere.

### Advantageous Effects

According to the present invention, a positive electrode active material may be simply synthesized, and a high-capacity positive electrode active material may be prepared.

### BEST MODE

Hereinafter, embodiments of the present invention will be described in detail. However, the embodiments are described for illustrative purpose, but the present invention is not limited thereto. Therefore, the present invention will be defined by the scope of the appended claims to be described below.

A positive electrode active material according to an embodiment of the present invention contains a composite oxide represented by the following Chemical Formula 1, has an average particle size of 5 to 15 μm, and includes secondary particles. In this case, the particle may include a spherical particle, an oval particle, and a plate type particle, but is not limited thereto.

LiₓNi_{y}Fe_{z}Mn_{w}O₂ [Chemical Formula 1]

(Where, x, y, and z satisfy the following Equations, respectively: 1≦x≦1.8, 0<y≦0.13, 0<z≦0.13, and 0.6≦w≦1.)

More specifically, the positive electrode active material according to the present invention contains a composite oxide represented by the following Chemical Formula 2 or 3, has the average particle size of 5 to 15 μm and includes secondary particles. In this case, the particle may include a spherical particle, an oval particle, and a plate type particle, but is not limited thereto.

Li_{1.2}Ni_{0.13}Fe_{0.13}Mn_{0.74}O₂ [Chemical Formula 2]

Li_{1.2}Ni_{0.104}Fe_{0.104}Mn_{0.592}O₂ [Chemical Formula 3]

The average particle size of the particle in the positive electrode active material may be 5 to 15 μm When the average particle size is less than 5 μm tap density of the active material may be decreased, and when the average particle size is more than 15 μm particle distribution of the active material is not uniform, such that the tap density may be decreased. In addition, when the size of the particle is excessively large, a diffusion length of Li positive ions becomes long, such that electro-chemical properties may be deteriorated.

The composite oxide may have pores having a size of 50 to 150 nm in the particle, and in order to form the pores, a carbon source material may be used. In the case in which the pore size is less than 50 nm, an amount of an electrolyte solution capable of being impregnated into the particle is insignificant, such that there is no influence on the electrochemical properties, and in the case in which the pore size is more than 150 nm, internal pores are excessively large such that an impregnation property of the electrolyte solution may be good, but strength of the particle may be decreased. Therefore, the spherical particle may be broken at the time of manufacturing an electrode.

As the carbon source material, at least one kind selected from a group consisting of sucrose, polyvinylalcohol, polyethyleneglycol, oxalic acid, resorcinol, citric acid, and cellulose acetate may be used, but the present invention is not limited thereto.

Next, a method for preparing a positive electrode active material according to the present invention will be described in detail.

The method for preparing a high-capacity positive electrode active material for a lithium secondary battery includes:

adding a nickel source material, an iron source material, and a manganese source material to a solvent to prepare a metal mixed solution;

controlling a pH of the metal mixed solution between 5 to 12 to induce a reaction of the metal mixed solution;

drying the hydrate prepared by the reaction in a vacuum oven; and

mixing a lithium source material with the hydrate and then heat-treating the mixture under inert atmosphere.

More specifically, first, the nickel source material, the iron source material, and the manganese source material are added to the solvent to thereby prepare a mixed dispersion solution. In this case, a mixing ratio of the lithium source material, the nickel source material, the iron source material, and the manganese source material are adjusted so that a molar ratio of Li:Ni:F:Mn is 1-1.8:0.01-0.13:0.01-0.13:0.6-1.

As the nickel source material, the iron source material, and manganese source material, a nickel salt, an iron salt, and a manganese salt that include one selected from a group consisting of acetate, nitrate, sulfate, carbonate, citrate, phtalate, perchlorate, acetylacetonate, acrylate, formate, oxalate, halide, oxyhalide, boride, oxide, sulfide, peroxide, alkoxide, hydroxide, ammonium, acetylacetone, hydrates thereof, and combination thereof may be preferably used, respectively.

In addition, at the time of preparing the mixed solution, the carbon source material may be further added in order to have a micropore or mesopore structure after sintering.

As the carbon source material, at least one kind selected from a group consisting of sucrose, polyvinylalcohol, polyethyleneglycol, oxalic acid, resorcinol, citric acid, and cellulose acetate may be used, but the present invention is not limited thereto. It is preferable that the carbon source material is added at a content of 0.1 to 0.5 mole % based on the total content of the metal since pores having a size of 50 to 150 nm may be formed.

As the solvent, distilled water, alcohol, or the like, may be used.

In this case, for vertically uniform mixing at the time of preparing the metal mixed solution, a reactor installed with two reverse rotational rotary blades may be preferably used, an output of a rotation motor may be preferably 2.4 kW or more, and a revolution thereof may be preferably 1000 to 2000 rpm.

After preparing the metal mixed solution, the pH of the metal mixed solution is controlled to 5 to 12 to induce a reaction of the metal mixed solution. When the pH is less than 5, Ni and Mn are not precipitated, and when the pH is more than 12, Fe is dissolved but not precipitated, such that a final compound is not formed. At the time of the reaction, an average temperature may be maintained at 40 to 60° C., and the hydrate prepared after the reaction is dried in the vacuum oven at 50 to 70° C. for 10 to 30 hours so that iron (Fe) atoms are not oxidized.

The lithium source material is added to the composite hydrate of nickel, iron, and manganese obtained as described above.

As the lithium source material, lithium fluoride, lithium carbonate, lithium hydroxide, lithium nitrate, lithium acetate or a mixture thereof may be used.

Then, the mixture is fired at 500 to 800° C. and a rate of 1 to 2° C./min under inert atmosphere, such that uniform particles having an average particle size of 5 to 15 μm may be prepared. The heat treatment under inert atmosphere ((N₂, Ar, or H₂/Ar=95:5 or 90:10) may be performed at 500 to 800° C. for 3 to 10 hours. In the case in which a temperature at the time of the heat treatment is in the above-mentioned range, uniform particles having a size of 5 to 15 μm may be prepared.

The prepared primary particles may have crystallinity and be represented by the following Chemical Formula 1, more specifically, represented by Chemical Formula 2 or 3.

LiₓNi_{y}Fe_{z}Mn_{w}O₂ [Chemical Formula 1]

(Where, x, y, and z satisfy the following Equations, respectively: 1≦x≦1.8, 0<y≦0.13, 0<z≦0.13, and 0.6≦w≦1.)

Li_{1.2}Ni_{0.13}Fe_{0.13}Mn_{0.74}O₂ [Chemical Formula 2]

Li_{1.2}Ni_{0.104} Fe_{0.104}Mn_{0.592}O₂ [Chemical Formula 3]

The method for preparing a positive electrode active material according to the embodiment of the present invention, which is a method for preparing a mixed dispersion solution, may be easily performed as compared with a hydrothermal synthesis method, a precipitation method, a sol-gel method, or the like. Further, according to the present invention, the composite oxide having a uniform size may be synthesized, and the nickel source material, the iron source material, the lithium source material and the manganese source material may be uniformly mixed, and a spherical precursor may be prepared.

The positive electrode active material according to the embodiment of the present invention may be usefully used in a positive electrode of a lithium secondary battery. The lithium secondary battery may include the positive electrode, a negative electrode containing a negative electrode active material, and a non-aqueous electrolyte.

The positive electrode may be prepared by mixing the positive electrode active material according to the embodiment of the present invention, a conductive material, a binding material, and the solvent to prepare a positive electrode active material composition, and then directly coating and drying the positive electrode active material composition onto an aluminum current collector. Alternatively, the positive electrode may be prepared by casting the positive electrode active material composition on a separate supporter, separating a film from the supporter, and laminating the obtained film on the aluminum current collector.

In this case, as the conductive material, carbon black, graphite, and metal powder may be used, and as the binding material, any one or a mixture of at least two selected from a vinylidene fluoride/hexafluoropropylene copolymer, polyvinylidene fluoride, polyacrylonitrile, polymethylmethacrylate, and polytetrafluoroethylene may be used. In addition, as the solvent, N-methylpyrrolidone, acetone, tetrahydrofuran, decane, and the like, may be used. In this case, the positive electrode active material, the conductive material, the binding material, and the solvent may be used at the content level at which they are generally used in the lithium secondary battery.

The negative electrode may be prepared by mixing the negative electrode active material, a binding material, and the solvent to prepare an negative electrode active material composition and then directly coating the negative electrode active material composition onto a copper current collector, or casting the negative electrode active material composition on a separate supporter and laminating the negative electrode active material film separated from the support on the copper current collector, similarly to the positive electrode. In this case, the negative electrode active material composition may further contain a conductive material, as needed.

As the negative electrode active material, a material capable of performing intercalation/de-intercalation of lithium may be used. For example, a lithium metal, a lithium alloy, lithium titanate, silicon, a tin alloy, cokes, artificial graphite, natural graphite, an organic polymer compound, a combustible material, carbon fiber, or the like, may be used. Further, the conductive material, the binding material, and the solvent may be same as those in the case of the above-mentioned cathode.

Any separator may be used as long as the separator is generally used in the lithium secondary battery. For example, polyethylene, polypropylene, polyvinylidene fluoride, or multi-layer having at least two thereof may be used as the separator, and a mixed multi-layered separator such as a polyethylene/polypropylene double-layered separator, a polyethylene/polypropylene/polyethylene triple-layered separator, polypropylene/polyethylene/polypropylene triple-layered separator, and the like, may also be used.

As the electrolyte filled in the lithium secondary battery, a non-aqueous electrolyte, a solid electrolyte known in the art, or the like, may be used, and an electrolyte in which lithium salts are dissolved may be used.

A solvent of the non-aqueous electrolyte is not particularly limited, but cyclic carbonates such as ethylene carbonate, propylene carbonate, butylene carbonate, vinylene carbonate, or the like; chain carbonates such as dimethyl carbonate, methylethyl carbonate, diethyl carbonate, or the like; esters such as methyl acetate, ethyl acetate, propyl acetate, methyl propionate, ethyl propionate, γ-butyrolactone, or the like; ethers such as 1,2-dimethoxyethane, 1,2-diethoxyethane, tetrahydrofuran, 1,2-dioxane, 2-methyltetrahydrofuran, or the like; nitriles such as acetonitrile, or the like; or amides such as dimethylformamide, or the like, may be used. One of these solvents may be used alone, or a plurality of solvents may be combined to thereby be used. Particularly, a mixed solvent of the cyclic carbonate and the chain carbonate may be preferably used.

Further, as the electrolyte, a gel phase polymer electrolyte in which a polymer electrolyte such as polyethyleneoxide, polyacrylonitrile, or the like, is impregnated with an electrolyte solution, or an inorganic solid electrolyte such as LiI, Li₃N, or the like, may be used.

In this case, the lithium salt may be one kind selected from a group consisting of LiPF₆, LiBF₄, LiSbF₆, LiAsF₆, LiCLO₄, LiCF₃SO₃, Li(CF₃SO₂)₂N, LiC₄F₉SO₃, LiSbF₆, LiAlO₄, LiAlCl₄, LiCl, and LiI.

As described above, according to the present invention, the positive electrode active material, which is the composite oxide capable of being easily prepared, prepared on a large scale, and having a uniform size, may be obtained. In addition, the positive electrode active material having high capacity, high energy density, and excellent thermal stability may be obtained.

A simple modification or change of the present invention may be easily performed by those skilled in the art, but this modification or change should be considered to be within the scope of the invention.

Hereinafter, Examples will be provided in order to describe the present invention in more detail. However, the present invention is not limited to the following Examples.

The physical properties were measured by the following measuring methods.

1) Capacity (mAh/g)

A half cell of a 2032 coin type cell was manufactured using a lithium metal as a negative electrode, and the capacity was measured at charging and discharging voltages of 2.0V to 4.6V at 0.1 C.

### EXAMPLE 1

Sucrose (0.5 mol %) was added to a mixed solution (2M) of nickel sulfate, iron sulfate, and manganese sulfate to prepare a metal solution.

The prepared metal solution was put into a 4 L reactor at a rate of 300 ml/1 hr, NH₄OH was added thereto as a chelating agent, and a pH was controlled by NaOH. At this time, a reaction temperature was 50° C. The total synthesis time was 24 hours. The finally synthesized precursor was washed with distilled water and then dried in a vacuum oven at 60° C. for 20 hours so that Fe was not oxidized.

LiOH was added to the dried Ni—Fe—Mn(OH)₂ precursor as a lithium source material so that the mixture has a molar ratio shown in the following Table 1, and then mixed with each other. After mixing, firing was performed at 800° C. for 15 hours under inert atmosphere (N₂) , thereby preparing a positive electrode active material having an average particles size of 10 μm.

Physical properties of the prepared positive electrode active material were shown in the following Table 1.

### EXAMPLES 2 TO 9

A positive electrode active material having an average particles size of 10 μm was prepared at the same conditions as those in Example 1 except that at the time of the synthesis, the pH and the molar ratio of the source materials were controlled as shown in Table 1.

Physical properties of the prepared positive electrode active material were shown in the following Table 1.

### COMPARATIVE EXAMPLE 1

A positive electrode active material having an average particles size of 10 μm was prepared at the same conditions as those in Example 1 except that at the time of the synthesis, the pH was controlled to 4 as shown in Table 1.

Physical properties of the prepared positive electrode active material were shown in the following Table 1.

### COMPARATIVE EXAMPLE 2

A positive electrode active material having an average particles size of 10 μm was prepared at the same conditions as those in Example 1 except that at the time of the synthesis, the pH was controlled to 13 as shown in Table 1.

Physical properties of the prepared positive electrode active material were shown in the following Table 1.

### COMPARATIVE EXAMPLE 3

A positive electrode active material having an average particles size of 10 μm was prepared at the same conditions as those in Example 1 except that at the time of the synthesis, the molar ratio of the source materials was controlled as shown in Table 1.

Physical properties of the prepared positive electrode active material were shown in the following Table 1.

### COMPARATIVE EXAMPLE 4

A positive electrode active material having an average particles size of 10 μm was prepared at the same conditions as those in Example 1 except that at the time of the synthesis, the molar ratio of the source materials was controlled as shown in Table 1.

Physical properties of the prepared positive electrode active material were shown in the following Table 1.

TABLE 1

| | Synthetic | | Capacity |
|---|---|---|---|
| | pH | Chemical composition | (mAh/g) |
| Example 1 | 5 | Li_{1.2}Ni_{0.13}Fe_{0.13}Mn_{0.74}O₂ | 175 |
| Example 2 | 6 | Li_{1.2}Ni_{0.13}Fe_{0.13}Mn_{0.74}O₂ | 210 |
| Example 3 | 7 | Li_{1.2}Ni_{0.13}Fe_{0.13}Mn_{0.74}O₂ | 220 |
| Example 4 | 8 | Li_{1.2}Ni_{0.13}Fe_{0.13}Mn_{0.74}O₂ | 240 |
| Example 5 | 9 | Li_{1.2}Ni_{0.13}Fe_{0.13}Mn_{0.74}O₂ | 255 |
| Example 6 | 10 | Li_{1.2}Ni_{0.13}Fe_{0.13}Mn_{0.74}O₂ | 245 |
| Example 7 | 11 | Li_{1.2}Ni_{0.13}Fe_{0.13}Mn_{0.74}O₂ | 232 |
| Example 8 | 12 | Li_{1.2}Ni_{0.13}Fe_{0.13}Mn_{0.74}O₂ | 200 |
| Example 9 | 9 | Li_{1.2}Ni_{0.104}Fe_{0.104}Mn_{0.592}O₂ | 250 |
| Comparative | 4 | Li_{1.2}Ni_{0.13}Fe_{0.13}Mn_{0.74}O₂ | 20 |
| Example 1 | | | |
| Comparative | 13 | Li_{1.2}Ni_{0.13}Fe_{0.13}Mn_{0.74}O₂ | 10 |
| Example 2 | | | |
| Comparative | 9 | Li_{1.09}Ni_{0.33}Fe_{0.33}Mn_{0.33}O₂ | 40 |
| Example 3 | | | |
| Comparative | 9 | Li_{1.9}Ni_{0.22}Fe_{0.22}Mn_{0.56}O₂ | 30 |
| Example 4 | | | |

As shown in Table 1, it may be appreciated that the positive electrode active material having excellent capacity was prepared in the pH range of 5 to 12 at the time of preparing the positive electrode active material according to the present invention.

In addition, as shown in Comparative Examples 3 and 4, it may be appreciated that when the molar ratio of the positive electrode active material was out of the range of the present invention, the capacity was significantly decreased.

1. A high-capacity positive electrode active material for a lithium secondary battery comprising a composite oxide of Chemical Formula 1.
LiₓNi_{y}Fe_{z}Mn_{w}O₂ [Chemical Formula 1]
(Where, x, y, and z satisfy the following Equations, respectively: 1≦x≦1.8, 0<y≦0.13, 0<z≦0.13, and 0.6≦w≦1.)

2. The high-capacity positive electrode active material for a lithium secondary battery of claim 1, wherein the composite oxide of Chemical Formula 1 is a composite oxide of the following Chemical Formula 2 or 3.
Li_{1.2}Ni_{0.13}Fe_{0.13}Mn_{0.74}O₂ [Chemical Formula 2]
Li_{1.2}Ni_{0.104}Fe_{0.104}Mn_{0.592}O₂ [Chemical Formula 3]

3. The high-capacity positive electrode active material for a lithium secondary battery of claim 1, wherein the composite oxide has pores having a size of 50 to 150 nm in particles.

4. The high-capacity positive electrode active material for a lithium secondary battery of claim 1, wherein the composite oxide has an average particle size of 5 to 15 μm.

5. A lithium secondary battery comprising:
a positive electrode containing the high-capacity positive electrode active material for a lithium secondary battery of claim 1;
a negative electrode containing a negative electrode active material; and
a non-aqueous electrolyte solution.

6. A method for preparing a high-capacity positive electrode active material for a lithium secondary battery, the method comprising:
adding a nickel source material, an iron source material, and a manganese source material to a solvent to prepare a metal mixed solution;
controlling a pH of the metal mixed solution between 5 to 12 to induce a reaction of the metal mixed solution;
drying the hydrate prepared by the reaction in a vacuum oven; and
mixing a lithium source material with the hydrate and then heat-treating the mixture under inert atmosphere.

7. The method of claim 6, wherein the drying of the hydrate is performed at 50 to 70° C. for 10 to 30 hours.

8. The method of claim 6, wherein in the preparing of the metal mixed solution, the solvent is distilled water, alcohol or a mixture thereof.

9. The method of claim 6, wherein in the preparing of the metal mixed solution, a carbon source material is further added at a content of 0.1 to 0.5 mol % based on the total content of the metal.

10. The method of claim 9, wherein the carbon source material is at least one kind selected from a group consisting of sucrose, polyvinylalcohol, polyethyleneglycol, oxalic acid, resorcinol, citric acid, and cellulose acetate.

11. The method of claim 6, wherein a mixing ratio of the lithium source material, the nickel source material, the iron source material, and the manganese source material are adjusted so that a molar ratio of Li:Ni:F:Mn is 1-1.8:0.01-0.13:0.01-0.13:0.6-1.

12. The method of claim 6, wherein the heat-treating under inert atmosphere is performed at 500 to 800° C.
